(19) United States
(12) Patent Application Publication
(10) Pub. No.: US 2023/0038143 A1
(43) Pub. Date: Feb. 9, 2023

(54) ELECTRONIC DEVICE, METHOD, AND NON-TRANSITORY COMPUTER READABLE STORAGE MEDIUM FOR IDENTIFYING STATE OF VISUAL OBJECT CORRESPONDING TO USER INPUT USING NEURAL NETWORK

(71) Applicants: NCSOFT CORPORATION, Seongnam-si (KR); SEOUL NATIONAL UNIVERSITY R&DB FOUNDATION, SEOUL (KR)

(72) Inventors: Sehee Min, Seoul (KR); Kyungho Lee, Seongnam-si (KR); Sunmin Lee, Seoul (KR); Jehee Lee, Seoul (KR); Hanyoung Jang, Seongnam-si (KR)

(73) Assignees: NCSOFT CORPORATION, SEONGNAM-SI (KR); SEOUL NATIONAL UNIVERSITY R&DB FOUNDATION, SEOUL (KR)

(21) Appl. No.: 17/879,404

(22) Filed: Aug. 2, 2022

(30) Foreign Application Priority Data
Aug. 5, 2021 (KR) 10-2021-0103370

(51) Int. Cl. G06N 3/08; G06N 3/04

(52) U.S. Cl. CPC G06N 3/08; G06N 3/0454

(57) ABSTRACT

A non-transitory computer readable storage medium store one or more programs including instructions causing an electronic device to receive, while a visual object is in a first state among a plurality of states, a user input for switching a state of the visual object to a second state among the plurality of states; provide data regarding the user input as input data to a neural network for training of the neural network; identify a third state among the plurality of states, wherein the third state is an intermediate state for switching the first state to the second state; obtain, from the neural network, data regarding the third state as output data for the data regarding the user input; determine a compensation value for the data regarding the third state; and train, by providing the data regarding the compensation value to the neural network, the neural network.

### CROSS-REFERENCE TO RELATED APPLICATION(S)

This application is based on and claims priority under 35 U.S.C. §120 to Korean Patent Application No. 10-2021-0103370, filed on Aug. 5, 2021, in the Korean Intellectual Property Office, the disclosure of which are incorporated by reference herein their entirety.

### BACKGROUND

### Technical Field

One or more embodiments of the instant disclosure generally relate to an electronic device, a method, and non-transitory computer readable storage medium for identifying state of visual object corresponding to user input using neural network.

### Description of Related Art

A neural network may mean a model having ability to solve a problem by changing a coupling strength(also known as synapse weight, synaptic weight, and/or coupling coefficient) of synapses based on training nodes forming a network through a coupling of the synapses. The neural network may be trained through supervised learning or unsupervised learning.

For example, the supervised learning may mean learning performed by providing a label (or correct answer). Since the supervised learning requires the label, it may require fewer resources than the unsupervised learning to evaluate the reliability of output data derived from the neural network. On the other hand, since the supervised learning requires the label, it may require resources (e.g., time resources) for obtaining the label.

For another example, the unsupervised learning may mean learning performed without a label. Since the unsupervised learning does not require the label, it may not require resources for obtaining the label. On the other hand, since the unsupervised learning does not require the label, it may require more resources than the supervised learning to evaluate the reliability of output data derived from the neural network.

### SUMMARY

A state of a visual object in a virtual environment (e.g., a game) may be switched based on a user input regarding the visual object. For example, when a user input regarding the visual object is received while the visual object is in a first state, the visual object may be switched to a second state through at least one third state which is intermediate state from the first state. When a virtual environment (e.g., a game) including the visual object is an environment requiring a time limit required for switching of the visual object, it may be required to identify the at least one third state within a predetermined time in response to the user input.

Technical problems to be achieved in this document are not limited to those described above, and other technical problems not mentioned herein will be clearly understood by those having ordinary knowledge in the art to which the present disclosure belongs, from the following description.

According to an embodiment, a non-transitory computer readable storage medium may store one or more programs comprising instructions which, when executed by at least one processor of an electronic device, cause the electronic device to receive, while a visual object is in a first state among a plurality of states, a user input for switching a state of the visual object to a second state among the plurality of states; provide data regarding the user input as input data to a neural network for training of the neural network; identify, by using the neural network obtaining the data regarding the user input, a third state among the plurality of states, wherein the third state is an intermediate state for switching the first state to the second state; obtain, from the neural network, data regarding the third state as output data for the data regarding the user input; based at least in part on whether switching from the first state to the second state through the third state is performed within predetermined time, determine a compensation value for the data regarding the third state; and train, by providing the data regarding the compensation value to the neural network, the neural network.

According to an embodiment, a method executed in an electronic device may comprise receiving, while a visual object is in a first state among a plurality of states, a user input for switching a state of the visual object to a second state among the plurality of states; providing data regarding the user input as input data to a neural network for training of the neural network; identifying, by using the neural network obtaining the data regarding the user input, a third state among the plurality of states, wherein the third state is an intermediate state for switching the first state to the second state; obtaining, from the neural network, data regarding the third state as output data for the data regarding the user input; based at least in part on whether switching from the first state to the second state through the third state is performed within predetermined time, determining a compensation value for the data regarding the third state; and training, by providing the data regarding the compensation value to the neural network, the neural network.

An electronic device according to an embodiment, at least one memory configured to store instructions, when the instructions are executed, may comprise at least one processor configured to receive, while a visual object is in a first state among a plurality of states, a user input for switching a state of the visual object to a second state among the plurality of states; provide data regarding the user input as input data to a neural network for training of the neural network; identify, by using the neural network obtaining the data regarding the user input, a third state among the plurality of states, wherein the third state is an intermediate state for switching the first state to the second state; obtain, from the neural network, data regarding the third state as output data for the data regarding the user input; based at least in part on whether switching from the first state to the second state through the third state is performed within predetermined time, determine a compensation value for the data regarding the third state; and train, by providing the data regarding the compensation value to the neural network, the neural network.

The effects that can be obtained from the present disclosure are not limited to those described above, and any other effects not mentioned herein will be clearly understood to those having ordinary knowledge in the art to which the disclosure belongs, from the following description.

### BRIEF DESCRIPTION OF THE DRAWINGS

The above and other aspects, features, and advantages of certain embodiments of the disclosure will be more apparent from the following description, taken in conjunction with the accompanying, in which:

FIG. 1 illustrates an example of a visual object that switches a state according to a user input.

FIG. 2 is a simplified block diagram of an electronic device according to an embodiment.

FIG. 3 illustrates an example of a method of training a neural network used by an electronic device according to an embodiment.

FIG. 4 illustrates examples of states of visual objects used for a neural network used by an electronic device according to an embodiment.

FIG. 5 illustrates an example of a method of training another neural network used by an electronic device according to an embodiment.

FIG. 6 illustrates an example of a method of obtaining data regarding at least one state of a visual object using another neural network in an electronic device according to an embodiment.

FIG. 7 is a flowchart illustrating a method of training a neural network used to train another neural network according to an embodiment.

FIG. 8 is a flowchart illustrating a method of providing data to the other neural network through the neural network to train the other neural network, according to an embodiment.

FIG. 9 is a flowchart illustrating another method of providing data to the other neural network through the neural network to train the other neural network, according to an embodiment.

FIG. 10 is a flowchart illustrating a method of reducing a search range of data regarding a plurality of states of a visual object stored in a database interworking with the neural network while training the neural network, according to an embodiment.

### DETAILED DESCRIPTION

An electronic device, a method, and a non-transitory computer readable storage medium according to an embodiment can provide content including a visual object having high reactivity by identifying a state of a visual object to be changed in response to reception of a user input using different neural networks trained through different learning techniques.

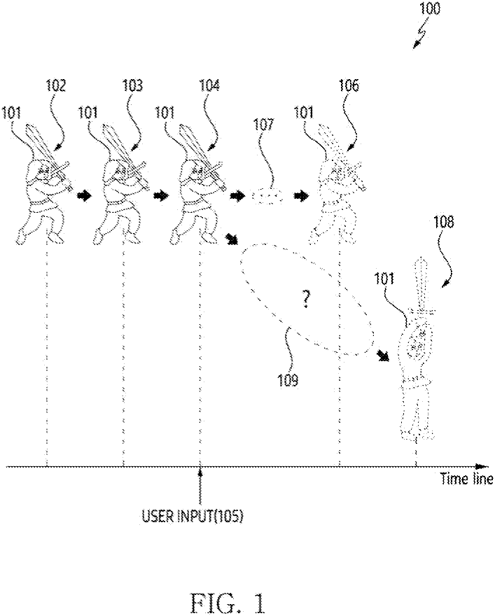

FIG. 1 illustrates an example of a visual object that switches a state according to a user input.

Referring to FIG. 1, a virtual environment 100 may include a visual object 101. The visual object 101 may change a state based on a user input. The state of the visual object 101 may include a change in a position of the visual object 101 according to the user input. For example, a position of the visual object 101 may be changed from the first position to the second position based on the user input. The state of the visual object 101 may include a change in direction of the visual object 101 according to the user input. For example, the direction of the visual object 101 may be changed from the first direction to the second direction based on the user input. The state of the visual object 101 may include a change in the posture of the visual object 101 according to the user input. For example, the posture of the visual object 101 may be changed from the first posture to the second posture based on the user input. In other words, the user input of the visual object 101 may be used in the virtual environment 100 to change at least one of the position of the visual object 101, the direction of the visual object 101, or the posture of the visual object 101.

Visual object 101 may have a plurality of states according to a plurality of user inputs. The plurality of states may be represented in the virtual environment 100 through motion of the visual object 101. For example, the visual object 101 may have at least one first state based on a first user input, and may have at least one second state based on a second user input received after receiving the first user input. The first state and the second state may configure the motion of the visual object 101 in the virtual environment 100.

Providing at least one intermediate state between the state of the visual object 101 defined (or identified) by the user input and the state of the visual object 101 immediately before receiving the user input may be required in the virtual environment 100 to configure the motion of the visual object 101. For example, the visual object 101 may have a state 104 switched from the state 102 through the state 103. When the user input 105 for the visual object 101 in the virtual environment 100 is not received, the visual object 101 in the state 104 may be switched to the state 106 through at least one intermediate state 107. Visual object 101 that was scheduled to be switched to state 106 may be switched from state 104 to state 108 through at least one other intermediate state 109 based on receiving user input 105 (or user input defining or identifying state 108) for switching state 104 to state 108. Since at least one other intermediate state 109 is not a state identified by user input 105, it may be required in the virtual environment 100 to identify at least one of the plurality of states that the visual object 101 may have. In addition, since switching the state of the visual object 101 from state 104 to state 108 through at least one other intermediate state 109 corresponds to representing the motion of the visual object 101 within the virtual environment 100, at least one other intermediate state (109) among the plurality of states, for the visual quality of the service provided through the virtual environment 100, may have to be identified as at least one state capable of providing the plausibility of motion of the visual object 101. In addition, since the motion of the visual object 101 within the virtual environment 100 represented by switching the state of the visual object 101 from the state 104 to the state 108 through at least one other intermediate state 109, represents the responsiveness of the service provided through the virtual environment 100, at least one other intermediate state 109 may have to be identified as at least one of the plurality of states capable of completing the switching to state 108 within a predetermined time.

In other words, for the quality of service provided through the virtual environment 100, it may be required to identify at least one other intermediate state 109 indicated in the virtual environment 100 after receiving the user input 105.

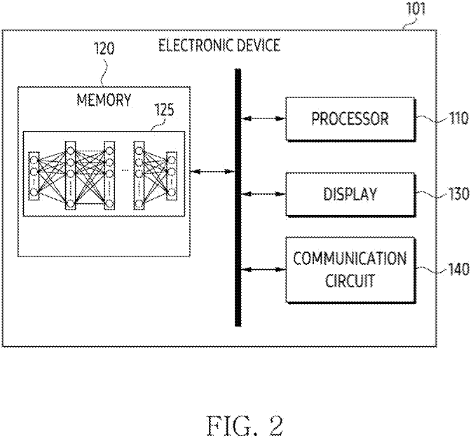

FIG. 2 is a simplified block diagram of an electronic device according to an embodiment.

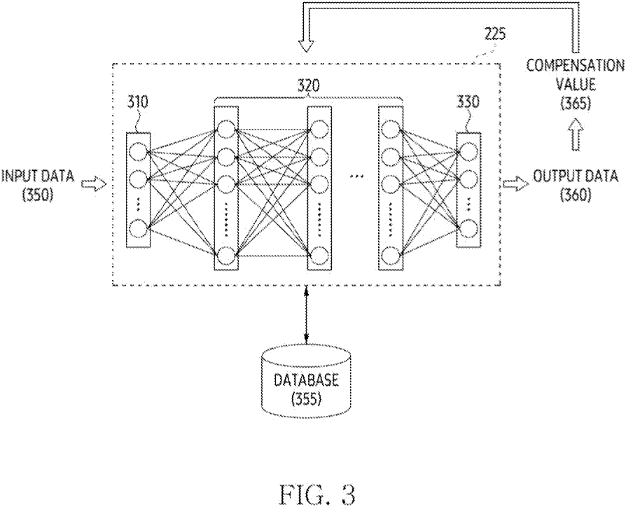

FIG. 3 illustrates an example of a method of training a neural network used by an electronic device according to an embodiment.

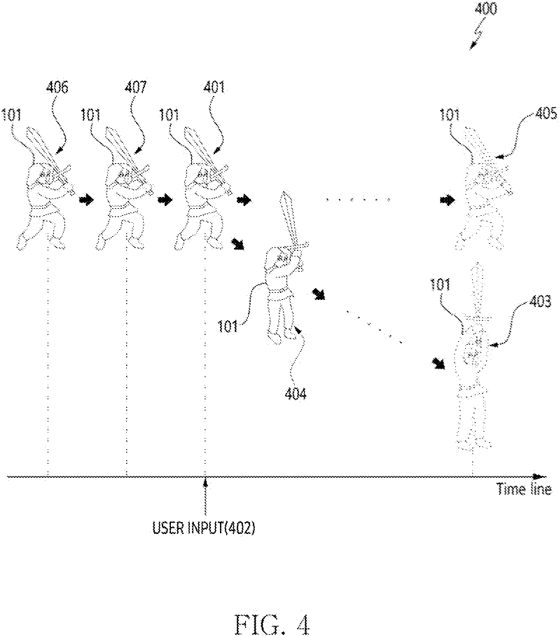

FIG. 4 illustrates examples of states of visual objects used for a neural network used by an electronic device according to an embodiment.

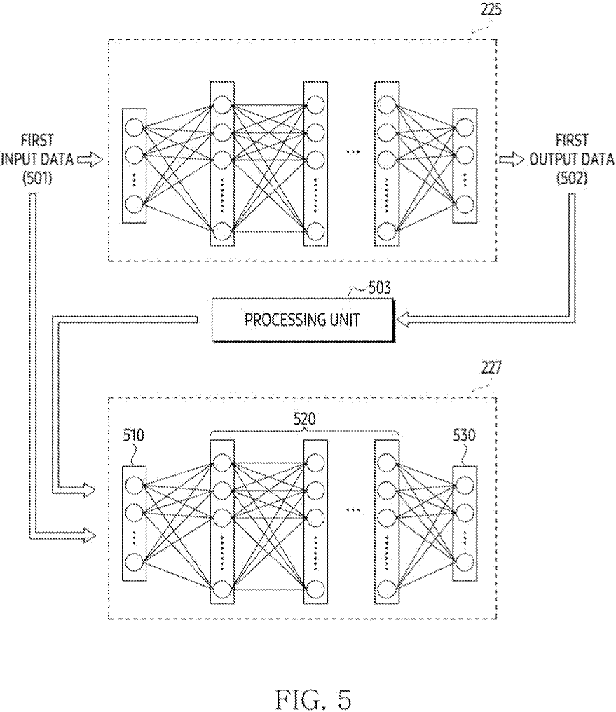

FIG. 5 illustrates an example of a method of training another neural network used by an electronic device according to an embodiment.

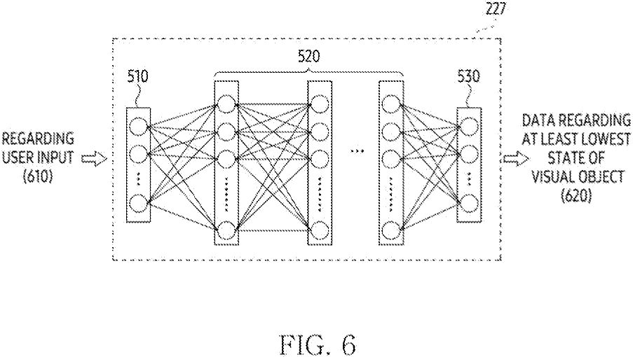

FIG. 6 illustrates an example of a method of obtaining data on at least one state of a visual object using another neural network in an electronic device according to an embodiment.

Referring to FIG. 2, the electronic device 201 may comprise at least one of a processor 210, a memory 220, a display 230, or a communication circuit 240. The processor 210, the memory 220, the display 230, and the communication circuit 240 may be electronically and/or operably coupled with each other by an electronical component such as a communication bus. The type and/or number of hardware components included in the electronic device 201 are not limited to those illustrated in FIG. 1. For example, the electronic device 201 may include only a part of the hardware components illustrated in FIG. 1.

The processor 210 of the electronic device 201 according to an embodiment may comprise a hardware component for processing data based on one or more instructions. Hardware components for processing data may include, for example, an Arithmetic and Logic Unit (ALU), a Field Programmable Gate Array (FPGA), and/or a Central Processing Unit (CPU). The processor 210 may include one or more cores. For example, the processor 210 may have a structure of a multi-core processor such as a dual core, a quad core, or a hexa core.

The memory 220 of the electronic device 201 according to an embodiment may include a hardware component for storing data and/or instructions input and/or output to the processor 210. The memory 220 may include, for example, a volatile memory such as a Random-Access Memory (RAM) and/or a non-volatile memory such as a Read-Only Memory (ROM). The volatile memory may include, for example, at least one of Dynamic RAM (DRAM), Static RAM (SRAM), Cache RAM, and Pseudo SRAM (PSRAM). The non-volatile memory may include, for example, at least one of a Programmable ROM (PROM), an Erasable PROM (EPROM), an Electrically Erasable PROM (EEPROM), a flash memory, a hard disk, a compact disk, and an Embedded Multi Media Card (eMMC).

Instructions indicating an operation to be performed by the processor 210 on data may be stored in the memory 220 of the electronic device 201 according to an embodiment. A set of instructions may be referred to as firmware, operating system, process, routine, sub-routine, and/or application.

A set of parameters related to the neural network 225 and the neural network 227 may be stored in the memory 220 of the electronic device 201 according to an embodiment. Each of the neural network 225 and the neural network 227 is a recognition model implemented with software or hardware that mimics the computational ability of a biological system using a large number of artificial neurons (or nodes). Each of the neural network 225 and the neural network 227 may perform human cognitive action, a learning process, or training through artificial neurons. Parameters related to each of the neural network 225 and the neural network 227 may represent, for example, a plurality of nodes included in each of the neural network 225 and the neural network 227 and/or an assigned weight to a connection between the plurality of nodes. A structure of the neural network 225 represented by a set of parameters stored in the memory 220 of the electronic device 201 according to an embodiment will be described later with reference to FIGS. 3 and 5. A structure of the neural network 227 represented by a set of parameters stored in the memory 220 of the electronic device 201 according to an embodiment will be described later with reference to FIGS. 5 and 6. The number of neural networks stored in the memory 220 is not limited to that illustrated in FIG. 2, and sets of parameters corresponding to each of the plurality of neural networks may be stored in the memory 220.

The display 230 of the electronic device 201 according to an embodiment may output visualized information to a user. For example, the visualized information may be used to configure a virtual environment such as virtual environment 100. For example, the display 230 may be controlled by a controller such as the processor 210 and/or a Graphic Processing Unit (GPU) to output visualized information to a user. The display 230 may include a Flat Panel Display (FPD) and/or electronic paper. The FPD may include a Liquid Crystal Display (LCD), a Plasma Display Panel (PDP), and/or one or more Light Emitting Diodes (LEDs). The LED may include an organic LED (OLED).

The communication circuit 240 of the electronic device 201 according to an embodiment may include a hardware component for supporting transmission and/or reception of an electrical signal between the electronic device 201 and an external electronic device. The communication circuit 240 may include, for example, at least one of a modem (MODEM), an antenna, and an O/E (Optical/Electronic) converter. The communication circuit 240 may support transmission and/or reception of electrical signals based on various types of protocols such as Ethernet, Local Area Network (LAN), and Wide Area Network (WAN), Wireless Fidelity (WiFi), Bluetooth, Bluetooth Low Energy (BLE), ZigBee, Long Term Evolution (LTE), and 5G NR (New Radio).

In an embodiment, the processor 210 may train the neural network 225. In an embodiment, the neural network 225 may be a neural network used to train the neural network 227. In an embodiment, neural network 225 may be trained through unsupervised learning to train neural network 227. For example, the neural network 225 may be trained through reinforcement learning.

For example, referring to FIG. 3, the neural network 225 may include a plurality of layers. For example, the neural network 225 may include an input layer 310, one or more hidden layers 320, and an output layer 330. The input layer 310 may receive a vector representing input data (e.g., a vector having elements corresponding to the number of nodes included in the input layer 310). Signals generated at each of the nodes in the input layer 310 based on the input data may be transmitted from the input layer 310 to one or more hidden layers 320. The output layer 330 may obtain output data of the neural network 225 based on one or more signals received from one or more hidden layers 320. The output data may include a vector having elements corresponding to the number of nodes included in the output layer 330.

Meanwhile, one or more hidden layers 320 may be positioned between the input layer 310 and the output layer 330. One or more hidden layers 320 may be used to convert input data transferred through input layer 310 into easy data for solving a problem.

Meanwhile, the input layer 310, one or more hidden layers 320, and the output layer 330 may include a plurality of nodes. One or more hidden layers 320 may be a convolution filter or a fully connected layer in a convolution neural network (CNN), or various types of filters or layers connected based on a specified function or feature. In an embodiment, one or more hidden layers 320 may be layers based on a recurrent neural network (RNN) in which an output value is re-input into a hidden layer of a current time. In an embodiment, one or more hidden layers 320 may be configured in plural, and may form a deep neural network. For example, training a neural network 225 including one or more hidden layers 320 forming at least a part of the deep neural network may be referred to as deep learning.

Meanwhile, nodes included in one or more hidden layers 320 may be referred to as hidden nodes.

Meanwhile, nodes included in the input layer 310 and the one or more hidden layers 320 may be connected to each other through a connection line having a connection weight, and nodes included in the one or more hidden layers 320 and the output layer 330 may also be connected to each other through a connection line having a connection weight. Tuning and/or training neural network 225 may mean changing the connection weight between nodes included in each of the layers included in neural network 225 (e.g., input layer 310, one or more hidden layers 320, and output layer 330). For example, tuning or training of neural network 225 may be performed based on unsupervised learning.

In an embodiment, the processor 210 may provide input data 350 to the neural network 225 to train the neural network 225. For example, input data 350 may include data regarding a user input to a visual object. For example, the user input may be a user input for switching the first state of the visual object to a second state at the timing of receiving the user input. For example, referring to FIG. 4, the input data 350 may include data regarding a user input 402 to the visual object 101 in state 401 which is the first state. For example, the user input 402 may be a user input for switching the state 401 to the second state 403. For example, data regarding user input 402 included in input data 350 may include information on the posture of visual object 101 within state 403, information on the specified time required for completion of transition to state 403 to ensure the quality of service provided through virtual environment 400, information on the position of visual object 101 within state 403, and information on the direction of the visual object 101 within the state 403. However, it is not limited thereto.

Referring back to FIGS. 2 and 3, the processor 210 may identify a third state, which is an intermediate state for switching the first state to the second state, among a plurality of states of the visual object, using the neural network 225 obtained the input data including data on the user input. In an embodiment, each of the plurality of states may be in a predefined state, and data on the plurality of states may be pre-stored in a database 355. The neural network 225 may obtain data on the plurality of states through interworking with the database 355, based on obtaining input data 350 including data on the user input, and may identify the third state among the plurality of states based on the obtained data. For example, referring to FIG. 4, the neural network 225 obtained input data 350 including data on the user input 402 may obtain data on the plurality of states of the visual object 101 through interworking with the database 355. The processor 210 may identify the state 404 which is intermediate state for switching the state 401 to the state 403 among the plurality of states using the neural network 225 obtained the data and input data 350 for the plurality of states.

Referring back to FIGS. 2 and 3, the processor 210 may obtain data on the third state as output data 360 for the input data 350, based on identifying the third state. The processor 210 may determine a compensation value 365 for the output data 360 to train the neural network 225 through reinforcement learning.

In an embodiment, the processor 210 may identify whether switching from the first state to the second state through the third state is performed within the predetermined time to determine the compensation value 365. In an embodiment, the processor 210 may determine the compensation value 365 based on whether switching from the first state to the second state through the third state is performed within the predetermined time. For example, the processor 210 may determine a compensation value 365 of the case identifying that switching from the first state to the second state through the third state is performed (or completed) within the predetermined time to be higher than a compensation value 365 of a case identifying that switching from the first state to the second state through the third state is performed (or completed) after the predetermined time elapses from the timing of receiving the user input for the visual object. For example, referring to FIG. 4, the processor 210 may identify a time consumed by switching from the state 401 to the state 403 through the state 404, and may identify whether the time is longer than the predetermined time, may identify whether the time is longer than the predetermined time, may determine a compensation value 365 as a first value on a condition that the time is longer than the predetermined time, may determine a compensation value 365 as a second value lower than the first value on a condition that the time is equal to or shorter than the predetermined time. For example, the first value may be 1, and the second value may be 0. However, it is not limited thereto.

Referring back to FIGS. 2 and 3, in an embodiment, the processor 210 may determine the compensation value based on a difference between the first state and the third state. For example, switch from the first state to the second state may require plausibility for the quality of a service provided through the virtual environment including the visual object. For the plausibility, the processor 210 may determine the compensation value further based on a difference between the first state and the third state indicating a degree of similarity between the first state and the third state. For example, the difference between the first state and the third state may be identified based on a distance between data on the first state among the plurality of states stored in the database 355 and data on the third state among the plurality of states. For example, referring to FIG. 4, the processor 210 may determine a compensation value 365 further based on a difference between the state 401 and the state 404.

Referring back to FIGS. 2 and 3, the processor 210 may determine the compensation value 365 using Equation 1 below.

$$r = {r}_{p l a u s i b l i l i t y} + {r}_{t a s k}$$

In Equation 1, r represents the compensation value, r_{plausibility} represents a difference between the first state and the third state, and rₜₐₛₖ represents whether switching from the first state to the second state through the third state is completed within the predetermined time.

The r_{plausibility} of Equation 1 may be determined based on Equation 2 below.

$${r}_{p l a u s i b i l i t y} = {w}_{p l a u s i b i l i t y} ∥ {f}_{j} ⊖ {f}_{i} {∥}^{2}$$

In Equation 2, -w_{plausibility} represents a weight for determining the r_{plausibility}, fⱼ represents the third state, fᵢ represents the first state, and ⊖ represents a distance between data on the first state stored in the database 355 and data on the third state.

The ^{r}task of Equation 1 may be determined based on Equation 3 below.

$${r}_{\text{task}} = \text{} \text{} - {w}_{d} ∥ \hat{d} - d {∥}^{2} - {w}_{p} ∥ \hat{p} - p {∥}^{2}$$

In Equation 3, d represents a direction of the visual object in the first state, P represents a position of the visual object in the first state, d̂ represents the direction of the visual object in the second state represented by the user input, p̂ represents the position of the visual object in the second state represented by the user input, and each of w_{d} and wₚ represents a weight for determining rₜₐₛₖ.

In an embodiment, the processor 210 may apply the rₜₐₛₖ determined based on Equation 3 to Equation 1 on a condition that switching from the first state to the second state through the third state is completed within the predetermined time, and may apply the rₜₐₛₖ of Equation 1 as 0 on a condition that switching from the first state to the second state through the third state is not completed within the predetermined time. However, it is not limited thereto.

Meanwhile, as described above, the neural network 225 may identify the third state from data on the plurality of states stored in the database 355. Since neural network 225 identifies the third state from data on the plurality of states stored in database 355, reducing the search range of data on the plurality of states stored in the database 355 for identifying the third state may be required to enhance the responsiveness of the neural network 225. In an embodiment, the processor 210 may execute at least one operation (e.g., at least one operation for pruning) for reducing the search range.

For example, in response to receiving the user input to reduce the search range, the processor 210 may identify a fourth state of the visual object that was to be switched from the first state before receiving the user input among the plurality of states. The processor 210 may reduce the search range by identifying a part of the plurality of states used to identify the third state based on a difference between the second state and the fourth state. For example, referring to FIG. 4, in response to receiving the user input 402, the processor 210 may identify, the state 405 which is the fourth state which was scheduled to be switched before receiving the user input 402 from among the plurality of states from the state 401. The processor 210 may reduce the search range by identifying a part of the plurality of states to be used to identify the state 404 based on at least a part of the difference between the state 405 and the state 403.

For another example, the processor 210, to reduce the search range, in response to receiving the user input, based on at least one difference between states of the visual object before the first state among the plurality of states and a difference between a state immediately before the first state and the first state among states of the visual object before the first state, may identify a part of the plurality of states as a search target. In other words, processor 210, based on difference between states of the visual object before the first state among the plurality of states and a difference between a state immediately before the first state and the first state among states of the visual object before the first state, may identify a part of the plurality of states used to identify the third state. For example, referring to FIG. 4, the processor 210, in response to receiving user input 402 based on the difference between the states 406 and 407 which are the states before the state 401 and the difference between the state 407 and the state 401 which are the states immediately before the state 401, may reduce the search range by identifying a part of the plurality of states to be used to identify the state 404.

Referring back to FIGS. 2 and 3, in an embodiment, the processor 210 may identify a part of the plurality of states based on Equations 4 to 6 below, and may identify the third state among a part of the plurality of states.

$${V}_{a}^{\text{lower}} ( i , t ) = {r}_{\text{task}} ( {T}_{a} ( i , t ) ) + {D}_{a} ( i , t )$$

In Equation 4,

$${V}_{a}^{\text{lower}} ( i , t )$$

represents a value corresponding to a lower bound of some of the plurality of states, ^{r}task(Tₐ(i,t)) represents a difference between the second state and the fourth state, and Dₐ(i,t) represents a cumulative value of at least one difference between states of the visual object before the first state among the plurality of states and a difference between a state immediately before the first state and the first state among states of the visual object before the first state.

$${V}_{a} \left(i , j , t\right) = {r}_{\text{plausibility}} \left(i , j\right) + γ {D}_{a} \left(j , t - 1\right)$$

In Equation 5, Vₐ(i,j,t) represents a value representing each of the plurality of states, ^{r}plausibility(i,j) represents a difference between a candidate value to be identified as the third state and a value representing the first state, and Dₐ(j,t-1) represents at least one difference value between states before the first state for identifying the third state.

$$\begin{matrix}{arg min}_{j} {\left‖s \left({f}_{j}\right) - \left(s + Δ s\right)\right‖}^{2} , \\ \text{subject to} {V}_{a} \left(i , j , t\right) \geq {V}_{a}^{\text{lower}} \left(i , t\right)\end{matrix}$$

Equation 6 may be used to identify the third state among a part of the plurality of states derived based on Equation 4 and Equation 5.

Meanwhile, processor 210 may determine Dₐ(i, t) of Equation 4 based on Equation 7 below.

$${D}_{a} \left(i , t\right) = {max}_{j} \left({r}_{\text{plausibility}} \left(i , j\right) + γ {D}_{a} \left(j , t - 1\right)\right)$$

In Equation 7, i may be related to the first state when receiving the user input, and j may be related to the third state.

Meanwhile, the processor 210 may determine T_{α}(i, t) of Equation 4 based on Equation 8 below.

$${T}_{a} \left(i , t\right) = {T}_{i \to j} ⋅ {T}_{a} \left(j , t - 1\right)$$

In Equation 8, i may be related to the first state when receiving the user input, and j may be related to the third state.

Meanwhile, the processor 210 may provide the compensation value 365 to the neural network 225 in response to determining the compensation value 365. The neural network 225 may be trained based on the compensation value 365.

Meanwhile, when reliability of the output data obtained from the trained neural network 225 is greater than or equal to the reference reliability, the processor 210 may train the neural network 227 including the input layer 510, one or more hidden layers 520, and the output layer 530, using the neural network 225. For example, each of the input layer 510, the one or more hidden layers 520, and the output layer 530 may be configured to be the same as or similar to the input layer 310, the one or more hidden layers 320, and the output layer 330 defined through the description of FIG. 3.

For example, neural network 225 is used to train neural networks 227, and neural networks 227, when the neural network 227 may provide output data with reliability greater than or equal to the reference reliability based on training through the neural network 225, may be used to identify the motion of the visual object in the virtual environment while providing a service through the virtual environment. For example, neural network 225 may be trained based on unsupervised learning as described above, while neural network 227 may be trained based on supervised learning through neural network 225. For example, the neural network 225 may be configured as a teacher policy for the neural network 227, and the neural network 227 may be configured as a student policy for the neural network 225.

In an embodiment, in order to train the neural network 227, the processor 210 may provide first input data 501 provided to the neural network 225 configured to output output data having a reliability greater than or equal to the reference reliability and first output data 502 for first input data 501 to the neural network 227. In an embodiment, the processor 210 may obtain the second output data by further processing the first output data 502 using the processing unit 503, and in order to train the neural network 227, may provide the first input data 501 and the second output data to the neural network 227. For example, the processor 210, under the condition that the time interval of the motion of the visual object indicated by the first output data 502 is longer than the reference time interval, by performing time warping on the first output data 502 using the processing unit 503, may obtain the second output data switched from the first output data 502, and may provide the first input data 501 and the second output data to the neural network 227. For example, for the time warping, a laplacian motion editing scheme may be used by the processor 210.

In an embodiment, processor 210, when the reliability of the output data obtained from the neural network 227 trained through the neural network 225 is greater than or equal to the reference reliability, based on a user input received for the visual object in the virtual environment, may determine the motion of the visual object by identifying at least one state of the visual object using the neural network 227. For example, referring to FIG. 6, in response to receiving a user input to the visual object, the processor 210 may provide data 610 on the user input to the neural network 227 providing output data having reliability greater than or equal to the reference reliability as input data for identifying a motion (or at least one state) of the visual object from a timing of receiving the user input until another user input after the user input is received. Processor 210, using the neural network 227 obtained data 610 on the user input, may identify at least one state of the visual object from a timing of receiving the user input until another user input after the user input is received, and may obtain data 620 on the at least one state of the visual object from the neural network 227 as output data.

Referring back to FIG. 2, in an embodiment, the processor 210 may provide a service through the virtual environment including the visual object by controlling the motion of the visual object based on the output data such as data 620.

As described above, in an embodiment, the electronic device 201 may enhance the visual quality of a service provided through the virtual environment by determining a compensation value (e.g., a compensation value 365) provided to the neural network 225 while training the neural network 225 in consideration of the plausibility of switching the state of the visual object. In an embodiment, the electronic device 201 may enhance the responsiveness of a service provided through the virtual environment by determining a compensation value (e.g., a compensation value 365) provided to the neural network 225 while training the neural network 225 in consideration of the responsiveness of the visual object. In an embodiment, in order to reduce the time spent for training the neural network 225, the electronic device 201 may reduce the search range of data for the plurality of states of the visual object stored in the database 355 interworking with the neural network 225. In an embodiment, in order to enhance the responsiveness of the visual object, the electronic device 201 may perform time warping on the data before providing data for training of the neural network 227 to the neural network 227.

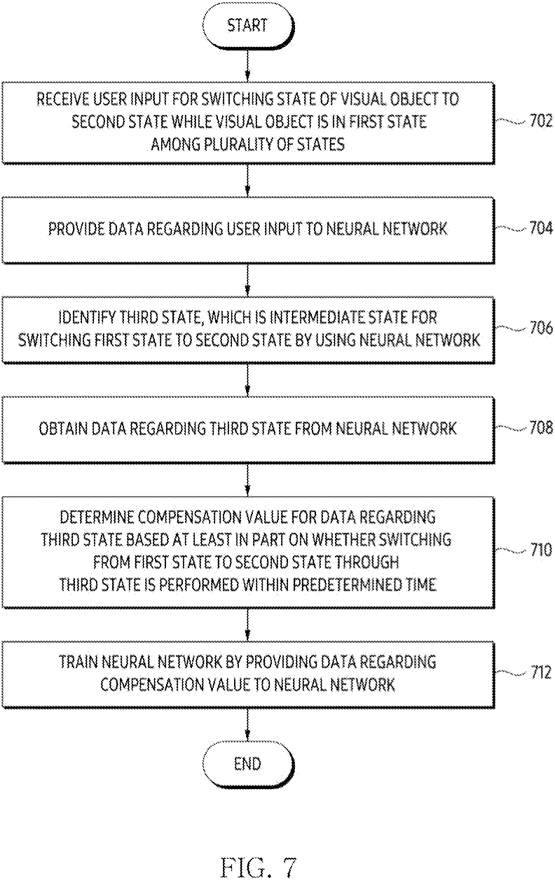

FIG. 7 is a flowchart illustrating a method of training a neural network used to train another neural network according to an embodiment. This method may be executed by a electronic device 201 or a processor 210 of the electronic device 201 illustrated in FIG. 2.

Referring to FIG. 7, in operation 702, processor 210 may receive a user input for switching the state of the visual object to a second state while the visual object in the virtual environment is within the first state among a plurality of states.

In operation 704, processor 210, in response to receiving the user input, for training a neural network (e.g., neural network 225) for training another neural network (e.g., neural network 227), may provide data on the user input to the neural network as input data.

In operation 706, the processor 210 may identify a third state, which is an intermediate state for switching the first state to the second state, using the neural network obtained the data on the user input as the input data.

In operation 708, the processor 210 may obtain data on the third state as output data on data on the user input from the neural network.

In operation 710, based at least in part on whether the switching of the visual object from the first state to the second state through the third state is performed within a predetermined time, may determine a compensation value for data on the third state. For example, the processor 210 may determine a compensation value for data on the third state based on Equation 3. However, it is not limited thereto. In an embodiment, the processor 210 may determine the compensation value further based on a difference between the first state and the third state. For example, the processor 210 may determine the compensation value based on Equations 1 and 2. However, it is not limited thereto. For example, unlike the illustration of FIG. 7, the processor 210 may determine the compensation value based on only Equation 2.

In operation 712, the processor 210 may train the neural network by providing data on the compensation value to the neural network.

As described above, in order to train the neural network used to train the other neural network, the electronic device 201 may determine a compensation value for the output data while the neural network provides output data having a lower reliability than the reference reliability. Since the compensation value is determined based on whether a time spent for switching from the first state to the second state through the third state is within the predetermined time and/or a difference between the first state and the third state, the electronic device 201 may enhance the responsiveness and/or viewability of the service of the virtual environment provided based on identifying the state of the visual object through the other neural network.

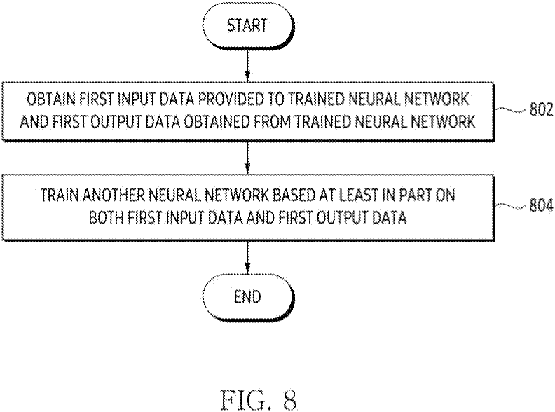

FIG. 8 is a flowchart illustrating a method of providing data to the other neural network through the neural network to train the other neural network, according to an embodiment. This method may be executed by the electronic device 201 or the processor 210 of the electronic device 201 illustrated in FIG. 2.

Operations 802 and 804 of FIG. 8 may be executed when the neural network trained through the method illustrated in FIG. 7 provides output data having reliability greater than or equal to a reference reliability.

Referring to FIG. 8, In operation 802, the processor 210 may obtain first input data provided to a neural network and first output data obtained from the neural network, which are trained through the method illustrated in FIG. 7 and may provide output data having reliability greater than or equal to a reference reliability. For example, the first input data may include data on a user input to the visual object, and the first output data may include data on at least one state of the visual object to be switched after receiving the user input.

In operation 804, the processor 210 may train another neural network trained through the neural network based on at least a part of both the first input data and the first output data. In other words, the processor 210 may train the other neural network through supervised learning using the neural network.

As described above, the electronic device 201, by training the other neural network through supervised learning using the neural network trained through the method illustrated in FIG. 7, may configure the other neural network for identifying a state of the visual object to be switched according to a user input while providing a service through the virtual environment. The electronic device 201 may enhance the efficiency of training of the other neural network by training the other neural network through the neural network after training the neural network.

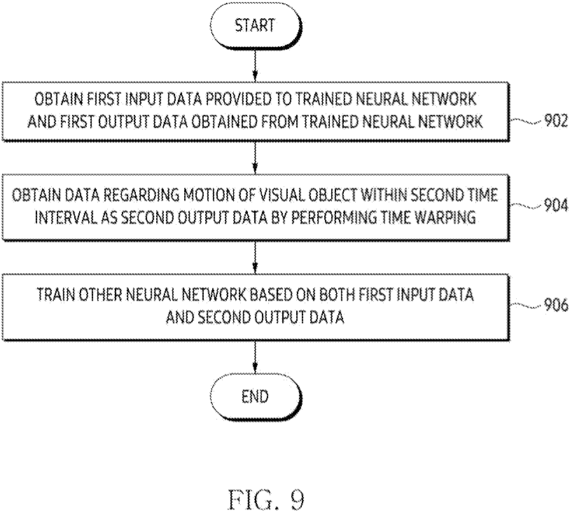

FIG. 9 is a flowchart illustrating another method of providing data to the other neural network through the neural network to train the other neural network, according to an embodiment. This method may be executed by the electronic device 201 or the processor 210 of the electronic device 201 illustrated in FIG. 2.

Operations 902 to 906 of FIG. 9 may be executed when the neural network trained through the method illustrated in FIG. 7 provides output data having reliability greater than or equal to a reference reliability.

In operation 902, the processor 210 may obtain first input data provided to a neural network and first output data obtained from the neural network, which are trained through the method illustrated in FIG. 7 and may provide output data having reliability greater than or equal to a reference reliability. For example, operation 902 may correspond to operation 802 defined through the description of FIG. 8.

In operation 904, the processor 210 may obtain, by performing a time warping with respect to a motion of the visual object within first time interval longer than reference time interval indicated based on the first output data, data regarding a motion of the visual object within second time interval shorter than the reference time interval. In an embodiment, operation 904 may be executed on condition that the first time interval, which is a time interval of motion indicated based on the first output data, is longer than the reference time interval. For example, on the condition that the first time interval, which is a time interval of motion indicated based on the first output data, is shorter than the reference time interval or the same as the reference time interval, processor 210 may bypass or omit executing operation 904 and operation 906. However, it is not limited thereto.

In operation 906, the processor 210 may train the other neural network based on both the first input data and the second output data in response to executing operation 904.

As described above, the electronic device 201, by configuring the data for training the other neural network with data obtained based on processing the output data obtained from the neural network, may train the other neural network to enhance service responsiveness to the virtual environment through the other neural network.

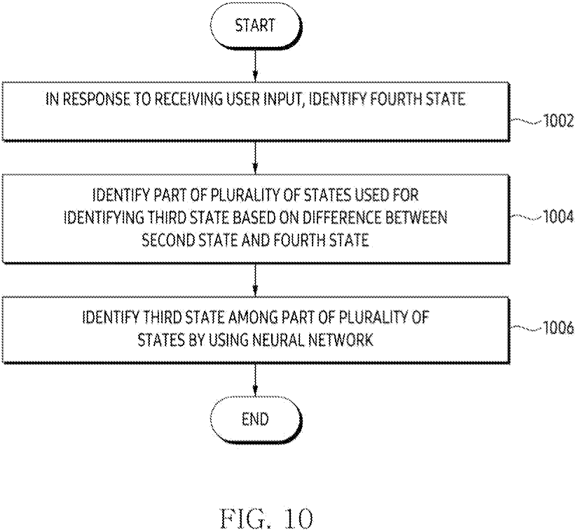

FIG. 10 is a flowchart illustrating a method of reducing a search range of data on a plurality of states of a visual object stored in a database interworking with the neural network while training the neural network, according to an embodiment. This method may be executed by the electronic device 201 or the processor 210 of the electronic device 201 illustrated in FIG. 2.

Operations 1002 to 1006 of FIG. 10 may be related to operations 702 to 706 of FIG. 7.

Referring to FIG. 10, in operation 1002, in response to receiving the user input in operation 702, processor 210 may identify a fourth state of the visual object that was to be switched from the first state before receiving the user input among the plurality of states.

In operation 1004, the processor 210 may identify a part of the plurality of states used to identify the third state based on at least a part of a difference between the second state and the fourth state. For example, data on the plurality of states may be stored in the database 355 illustrated in FIG. 3, and identifying a part of the plurality of states may mean narrowing a range of searching for data on the plurality of states to identify the third state. In an embodiment, the processor 210 may identify a part of the plurality of states further based on at least one difference between states of the visual object before the first state among the plurality of states and a difference between a state immediately before the first state and the first state among the states. However, it is not limited thereto.

In operation 1006, the processor 210 may identify the third state among a part of the plurality of states by using the neural network obtained data on the user input.

As described above, the electronic device 201 may reduce the time spent to train the neural network by performing pruning through operations 1002 to 1006. In other words, the electronic device 201 may enhance efficiency of training of the neural network.

As described above, non-transitory computer readable storage medium according to an embodiment, when executed by at least one processor of an electronic device, may store one or more programs comprising instructions which cause the electronic device to receive, while a visual object is in a first state among a plurality of states, a user input for switching a state of the visual object to a second state among the plurality of states; provide data regarding the user input as input data to a neural network for training of the neural network; identify, by using the neural network obtaining the data regarding the user input, a third state among the plurality of states, wherein the third state is an intermediate state for switching the first state to the second state; obtain, from the neural network, data regarding the third state as output data for the data regarding the user input; based at least in part on whether switching from the first state to the second state through the third state is performed within predetermined time, determine a compensation value for the data regarding the third state; and train, by providing the data regarding the compensation value to the neural network, the neural network.

In an embodiment, the one or more programs above, when executed by the at least one processor of the electronic device, may comprise instructions which further cause the electronic device to determine the compensation value further based on difference between the first state and the third state.

In an embodiment, the one or more programs above, when executed by the at least one processor of the electronic device, may comprise instructions which further cause the electronic device to obtain first input data provided to the neural network that is trained based on the compensation value and first output data regarding the first input data obtained from the neural network that is trained based on the compensation value; and train another neural network distinct from the neural network, based at least in part on both the first input data and the first output data.

In an embodiment, the one or more programs above, when executed by the at least one processor of the electronic device, may comprise instructions which further cause the electronic device to obtain, by performing a time warping with respect to a motion of the visual object within first time interval longer than reference time interval indicated based on the first output data, data regarding a motion of the visual object within second time interval shorter than the reference time interval as the second output data; and train, based on both the first input data and the second output data, the other neural network.

In an embodiment, the neural network may be used for training the other neural network.

In an embodiment, the neural network may obtain output data by processing input data provided to the neural network via use of a database storing information regarding the plurality of states, and wherein the other neural network may obtain output data by processing input data provided to the other neural network without use of the database.

In an embodiment, the one or more programs above, when executed by the at least one processor of the electronic device, may comprise instructions which further cause the electronic device to identify, in response to receiving the user input, a fourth state of the visual object that was to be switched from the first state before receiving the user input among the plurality of states; identify, based at least in part on difference between the second state and the fourth state, a part of the plurality of states used for identifying the third state; and identify the third state among the part of the plurality of states by using the neural network obtaining the data regarding the user input

In an embodiment, the one or more programs above, when executed by the at least one processor of the electronic device, may comprise instructions which further cause the electronic device to identify the part of the plurality of states, further based on at least one difference between states of the visual object before the first state among the plurality of states and difference between the first state and a state immediately before the first state among the states.

The electronic device according to various embodiments disclosed in the present document may be various types of devices. The electronic device may include, for example, a portable communication device (e.g., a smartphone), a computer device, a portable multimedia device, a portable medical device, a camera, a wearable device, or a home appliance. The electronic device according to an embodiment of the present document is not limited to the above-described devices.

The various embodiments and terms used herein are not intended to limit the technical features described herein to specific embodiments and should be understood to include various modifications, equivalents, or substitutes of the embodiment. With respect to the description of the drawings, similar reference numerals may be used for similar or related components. The singular form of the noun corresponding to the item may include one or more of the items unless clearly indicated differently in a related context. In this document, each of the phrases such as “A or B”, “at least one of A and B”, “at least one of A or B”, “A, B or C” “at least one of A, B and C”, and “at least one of A, B, or C” may include any one of the phrases together, or all possible combinations thereof. Terms such as “first”, “second”, or “second”, or “second” may be used simply to distinguish a corresponding component from another corresponding component, and are not limited to other aspects (e.g., importance or order). When some (e.g., the first) component is referred to as “coupled” or “connected” in another (e.g., the second) component, with or without the term “functional” or “communicatively”, it means that some of the components can be connected directly (e.g., wired), wirelessly, or through a third component.

The term “module” used in various embodiments of the present document may include a unit implemented in hardware, software, or firmware, and may be used interchangeably with terms such as, for example, logic, logic block, component, or circuit. The module may be an integrally configured component or a minimum unit or a part of the component that performs one or more functions. For example, according to an embodiment, the module may be implemented in the form of an application-specific integrated circuit (ASIC).

Various embodiments of the present document may be implemented as software (e.g., program 140) including one or more instructions stored in a storage medium (e.g., internal memory 136 or external memory 138) readable by a machine (e.g., electronic device 101). For example, the processor (e.g., processor 120) of the machine (e.g., electronic device 101) may call at least one of one or more instructions stored from the storage medium and may execute the instruction. This makes it possible for the machine to be operated to perform at least one function according to the at least one instruction called. The one or more instructions may include a code generated by a compiler or a code that may be executed by an interpreter. The storage medium readable by the machine may be provided in the form of a non-transitory storage medium. Here, ‘non-transitory’ only means that the storage medium is a tangible device and does not include a signal (e.g., electromagnetic waves), and the term does not distinguish between a case where data is semi-permanently stored in the storage medium and a case where it is temporarily stored.

According to an embodiment, a method according to various embodiments disclosed in the present document may be provided by being included in a computer program product. A computer program product may be traded between a seller and a buyer as a product. The computer program product may be distributed in the form of a machine-readable storage medium (e.g., compact disc read only memory (CD-ROM)), or may be distributed online (e.g., downloaded or uploaded) through an application store (e.g., a play store™) or directly between two user devices (e.g., smartphones). In the case of online distribution, at least a part of the computer program product may be at least temporarily stored or temporarily generated in a machine-readable storage medium such as a memory of a server of a manufacturer, a server of an application store, or a relay server.

According to various embodiments, each component (e.g., a module or a program) of the above-described components may include a singular or a plurality of entities, and some of the plurality of entities may be separately disposed in other components. According to various embodiments, one or more components or operations among the above-described corresponding components may be omitted, or one or more other components or operations may be added. Alternatively or additionally, a plurality of components (e.g., modules or programs) may be integrated into one component. In this case, an integrated component may perform one or more functions of each component of the plurality of components the same as or similar to those performed by a corresponding component among the plurality of components before the integration. According to various embodiments, operations performed by a module, program, or other component may be executed sequentially, in parallel, repeatedly, or heuristically, or one or more of the above operations may be executed in a different order, omitted, or one or more other operations may be added.

What is claimed is:

1. A non-transitory computer readable storage medium storing one or more programs, the one or more programs comprising instructions which, when executed by at least one processor of an electronic device, cause the electronic device to:
receive, while a visual object is in a first state among a plurality of states, a user input for switching a state of the visual object to a second state among the plurality of states;
provide data regarding the user input as input data to a neural network for training of the neural network;
identify, by using the neural network obtaining the data regarding the user input, a third state among the plurality of states, wherein the third state is an intermediate state for switching the first state to the second state;
obtain, from the neural network, data regarding the third state as output data for the data regarding the user input;
based at least in part on whether switching from the first state to the second state through the third state is performed within predetermined time, determine a compensation value for the data regarding the third state; and
train, by providing the data regarding the compensation value to the neural network, the neural network.

2. The non-transitory computer readable storage medium of claim 1, wherein the one or more programs comprise instructions which, when executed by the at least one processor of the electronic device, further cause the electronic device to determine the compensation value further based on difference between the first state and the third state.

3. The non-transitory computer readable storage medium of claim 1, wherein the one or more programs comprise instructions which, when executed by the at least one processor of the electronic device, further cause the electronic device to:
obtain first input data provided to the neural network that is trained based on the compensation value and first output data regarding the first input data obtained from the neural network that is trained based on the compensation value; and
train another neural network distinct from the neural network, based at least in part on both the first input data and the first output data.

4. The non-transitory computer readable storage medium of claim 3, wherein the one or more programs comprise instructions which, when executed by the at least one processor of the electronic device, further cause the electronic device to:
obtain, by performing a time warping with respect to a motion of the visual object within first time interval longer than reference time interval indicated based on the first output data, data regarding a motion of the visual object within second time interval shorter than the reference time interval as the second output data; and
train, based on both the first input data and the second output data, the other neural network.

5. The non-transitory computer readable storage medium of claim 4, wherein the neural network is used for training the other neural network.

6. The non-transitory computer readable storage medium of claim 4, wherein the neural network obtains output data by processing input data provided to the neural network via use of a database storing information regarding the plurality of states, and
wherein the other neural network obtains output data by processing input data provided to the other neural network without use of the database.

7. The non-transitory computer readable storage medium of claim 1, wherein the one or more programs comprise instructions which, when executed by the at least one processor of the electronic device, further cause the electronic device to:
identify, in response to receiving the user input, a fourth state of the visual object to be switched from the first state among the plurality of states, wherein identifying the fourth state is executed before receiving the user input;
identify, based at least in part on difference between the second state and the fourth state, a part of the plurality of states used for identifying the third state; and
identify the third state among the part of the plurality of states by using the neural network obtaining the data regarding the user input.

8. The non-transitory computer readable storage medium of claim 7, wherein the one or more programs comprise instructions which, when executed by the at least one processor of the electronic device, further cause the electronic device to identify the part of the plurality of states, further based on at least one difference states of the visual object before the first state among the plurality of states and difference between the first state and a state immediately before the first state among the states.

9. A method executed within an electronic device, the method comprising:
receiving, while a visual object is in a first state among a plurality of states, a user input for switching a state of the visual object to a second state among the plurality of states;
providing data regarding the user input as input data to a neural network for training of the neural network;
identifying, by using the neural network obtaining the data regarding the user input, a third state among the plurality of states, wherein the third state is an intermediate state for switching the first state to the second state;
obtaining, from the neural network, data regarding the third state as output data for the data regarding the user input;
based at least in part on whether switching from the first state to the second state through the third state is performed within predetermined time, determining a compensation value for the data regarding the third state; and
training, by providing the data regarding the compensation value to the neural network, the neural network.

10. The method of claim 9, wherein the operation of determining the compensation value includes determining the compensation value further based on difference between the first state and the third state.

11. The method of claim 10, further comprising
obtaining first input data provided to the neural network that is trained based on the compensation value and first output data regarding the first input data obtained from the neural network that is trained based on the compensation value; and
training another neural network distinct from the neural network, based at least in part on both the first input data and the first output data.

12. The method of claim 11, further comprising
obtaining, by performing a time warping with respect to a motion of the visual object within first time interval longer than reference time interval indicated based on the first output data, data regarding a motion of the visual object within second time interval shorter than the reference time interval as second output data; and
training, based on both the first input data and the second output data, the other neural network.

13. The method of claim 12, wherein the neural network is used to train the other neural networks.

14. The method of claim 12,
wherein the neural network obtains output data by processing input data provided to the neural network via use of a database storing information regarding the plurality of states, and
wherein the other neural network obtains output data by processing input data provided to the other neural network without use of the database.

15. The method of claim 9, further comprising
identifying, in response to receiving the user input, a fourth state of the visual object to be switched from the first state among the plurality of states, wherein identifying the fourth state is executed before receiving the user input;
identifying, based at least in part on difference between the second state and the fourth state, a part of the plurality of states used for identifying the third state; and
identifying the third state among the part of the plurality of states by using the neural network obtaining the data regarding the user input.

16. The method of claim 9, the operation of identifying a part of the plurality of states includes identifying the part of the plurality of states further based on difference states of the visual object before the first state among the plurality of states and difference between the first state and a state immediately before the first state among the states.

17. An electronic device comprising:
at least one memory configured to store instructions; and
the at least one processor,
wherein the at least one processor is, when the instructions are executed, configured to:
receive, while a visual object is in a first state among a plurality of states, a user input for switching a state of the visual object to a second state among the plurality of states;
provide data regarding the user input as input data to a neural network for training of the neural network;
identify, by using the neural network obtaining the data regarding the user input, a third state among the plurality of states, wherein the third state is an intermediate state for switching the first state to the second state;
obtain, from the neural network, data regarding the third state as output data for the data regarding the user input;
based at least in part on whether switching from the first state to the second state through the third state is performed within predetermined time, determine a compensation value for the data regarding the third state; and
train, by providing the data regarding the compensation value to the neural network, the neural network.

18. The electronic device of claim 17, wherein the at least one processor is, when the instructions are executed, further configured to
determine the compensation value further based on difference between the first state and the third state.

19. The electronic device of claim 17, wherein the at least one processor is, when the instructions are executed, further configured to
identify, in response to receiving the user input, a fourth state of the visual object to be switched from the first state among the plurality of states, wherein identifying the fourth state is executed before receiving the user input;
identify, based at least in part on difference between the second state and the fourth state, a part of the plurality of states used for identifying the third state; and
identify the third state among the part of the plurality of states by using the neural network obtaining the data regarding the user input.

20. The electronic device of claim 19, wherein the at least one processor is, when the instructions are executed, further configured to
identify the part of the plurality of states further based on difference states of the visual object before the first state among the plurality of states and difference between the first state and a state immediately before the first state among the states.
